(19) United States
(12) Patent Application Publication
(10) Pub. No.: US 2023/0300818 A1
(43) Pub. Date: Sep. 21, 2023

(54) FREQUENCY DOMAIN AGGREGATED PPDU (FA-PPDU) COMPRISING MULTIPLE PHY TYPES

(71) Applicant: Intel Corporation, Santa Clara, CA (US)

(72) Inventors: Juan Fang, Portland, OR (US); Po-Kai Huang, San Jose, CA (US); Qinghua Li, San Ramon, CA (US); Robert J. Stacey, Portland, OR (US); Thomas J. Kenney, Portland, OR (US); Minyoung Park, San Ramon, CA (US); Shlomi Vituri, Tel Alviv (IL)

(21) Appl. No.: 18/201,252

(22) Filed: May 24, 2023

(51) Int. Cl. H04W 72/121; H04W 72/0457

(52) U.S. Cl. CPC H04W 72/121; H04W 72/0457

(57) ABSTRACT

An access point station (AP) generates a trigger frame (TF) for transmission to two or more non-AP stations (STAs) or groups of STAs. The trigger frame may allocate resource units (RUs) for a trigger-based (TB) transmission to the two or more STAs. The AP may encode the trigger frame to include a Common Info field followed by one or more Special User Info fields. The Common Info field and the one or more Special User Info fields and may be encoded to solicit (i.e., trigger) a trigger-based (TB) Frequency Aggregated Physical layer Protocol Data Unit (PPDU) (FA-PPDU) that includes more than one PPDU of at least two different physical layer (PHY) types from the two or more STAs or groups of STAs. The different PHY types may include high-efficiency (HE), Extremely High Throughput (EHT), Ultra-High Rate (UHR), and UHR+. Accordingly, an AP can trigger a FA-PPDU that includes TB PPDUs of different PHY types.

### TECHNICAL FIELD

Embodiments pertain to wireless communications. Some embodiments relate wireless local area networks (WLANs) that operate in accordance with the IEEE 802.11 standards. Some embodiments relate to IEEE 802.11be Extremely High Throughput (EHT) (i.e., the IEEE P802.11-Task Group BE EHT) (Wi-Fi 7). Some embodiments relate to next generation Wi-Fi (Wi-Fi 8).

### BACKGROUND

One issue with communicating aggregated Physical layer Protocol Data Unit (A-PPDUs) is that the current WLAN standards do not allow for different physical layer (PHY) type PPDUs to be aggregated. This results is an inefficient use of bandwidth as portions of the channel end up being non-utilized since some STAs have limited PHY capabilities. Thus there are general needs for systems and methods that improve bandwidth utilization by allowing the transmission of A-PPDUs having PPDUs of different PHY types.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6A illustrates a Trigger Frame format, in accordance with some embodiments.

FIG. 6B illustrates a Common Info field format, in accordance with some embodiments.

FIG. 6C illustrates a User Infor field format, in accordance with some embodiments.

FIG. 6D illustrates a Special User Info field format, in accordance with some embodiments.

FIG. 7 is table 9-45c illustrating valid combination of B54 and B44 in the Common Info field, B39 in the User Info field, and solicited TB PPDU format.

FIG. 8 illustrates a TB-PPDU with PPDUs of the same PHY type.

FIG. 9 illustrates some fields of a Trigger Frame for soliciting a FA-PPDU having multiple different PHY version PPDU types, in accordance with some embodiments.

FIG. 10A illustrates signalling for a first example configuration, configuration 1, in accordance with some embodiments.

FIG. 10B illustrates a FA-PPDU of configuration 1, in accordance with some embodiments.

FIG. 11A illustrates signalling for a second example configuration, configuration 2, in accordance with some embodiments.

FIG. 11B illustrates a FA-PPDU of configuration 2, in accordance with some embodiments.

FIG. 12A illustrates signalling for a third example configuration, configuration 3, in accordance with some embodiments.

FIG. 12B illustrates a FA-PPDU of configuration 3, in accordance with some embodiments.

FIG. 13A illustrates signalling for a fourth example configuration, configuration 4, in accordance with some embodiments.

FIG. 13B illustrates a FA-PPDU of configuration 4, in accordance with some embodiments.

FIG. 14A illustrates signalling for a fifth example configuration, configuration 5, in accordance with some embodiments.

FIG. 14B illustrates a FA-PPDU of configuration 5, in accordance with some embodiments.

FIG. 15 illustrates a functional block diagram of a wireless communication device, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to an access point station (AP) configured to solicit a trigger-based (TB) Frequency Aggregated Physical layer Protocol Data Unit (PPDU) (FA-PPDU) that includes more than one PPDU of at least two different physical layer (PHY) types from the two or more STAs or groups of STAs.

In some embodiments, an access point station (AP) generates a trigger frame (TF) for transmission to two or more non-AP stations (STAs) or groups of STAs. In these embodiments, the trigger frame may allocate resource units (RUs) for a trigger-based (TB) transmission to the two or more STAs. In these embodiments, the AP may encode the trigger frame to include a Common Info field followed by one or more Special User Info fields. The Common Info field and the one or more Special User Info fields and may be encoded to solicit (i.e., trigger) a trigger-based (TB) Frequency Aggregated Physical layer Protocol Data Unit (PPDU) (FA-PPDU) that includes more than one PPDU of at least two different physical layer (PHY) types from the two or more STAs or groups of STAs. In these embodiments, the different PHY types may include high-efficiency (HE), Extremely High Throughput (EHT), Ultra-High Rate (UHR), and UHR+, although the scope of the embodiments is not limited in this respect. In these embodiments, the AP may decode the FA-PPDU received from the two or more STAs.

Accordingly, an AP can trigger a FA-PPDU that includes TB PPDUs of different PHY types. For example, the FA-PPDU may comprise an HE PPDU transmitted in a first bandwidth by an HE STA and an EHT PPDU in a second bandwidth transmitted by an EHT STA. For example, the FA-PPDU may comprise an EHT PPDU transmitted in the first bandwidth by an EHT STA and an UHR PPDU in the second bandwidth transmitted by a UHR STA. These embodiments, as well as others, are described in more detail below.

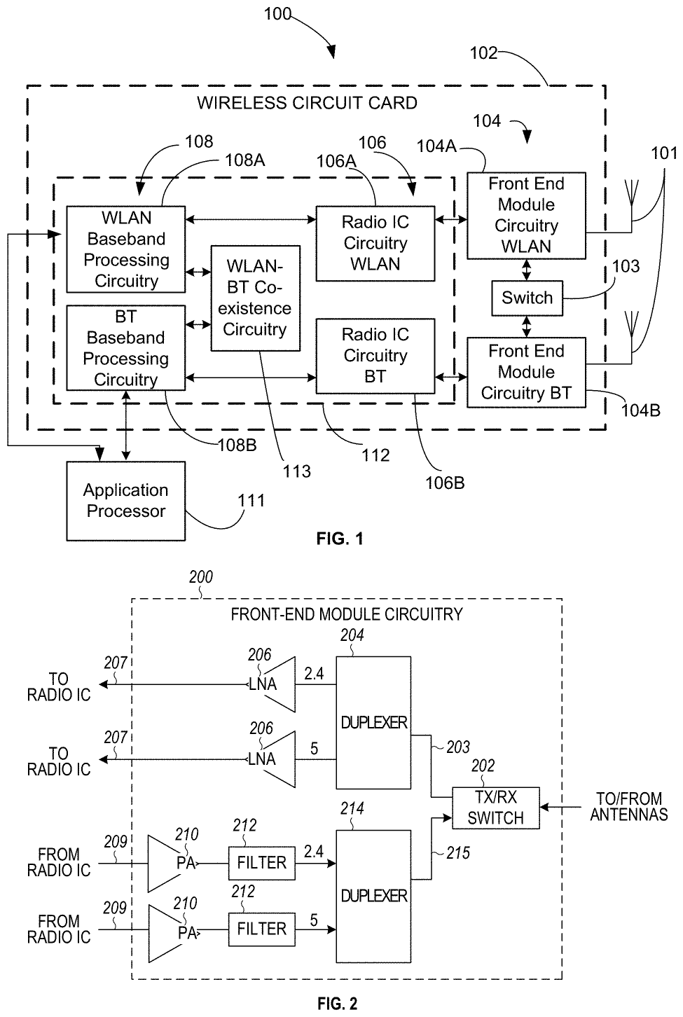

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

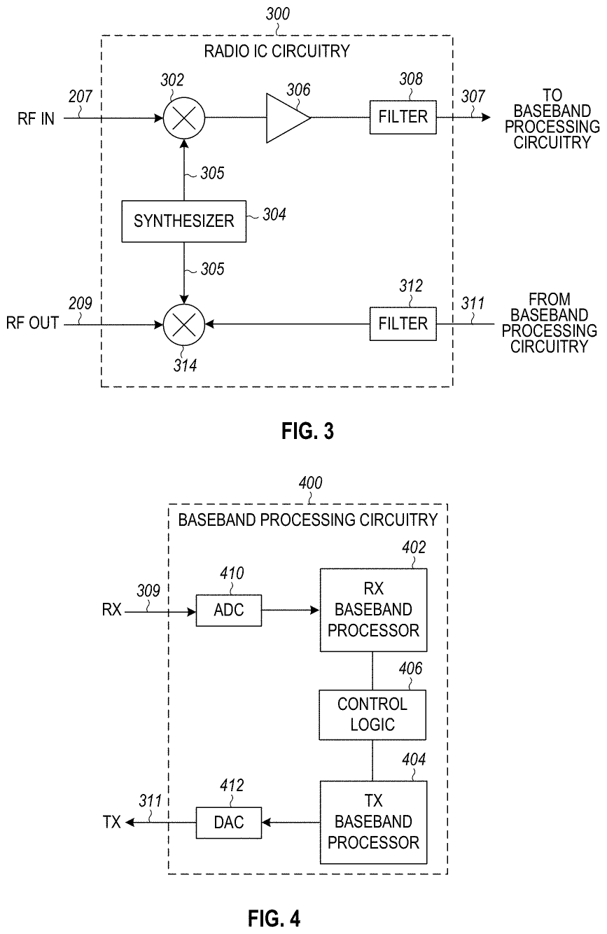

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

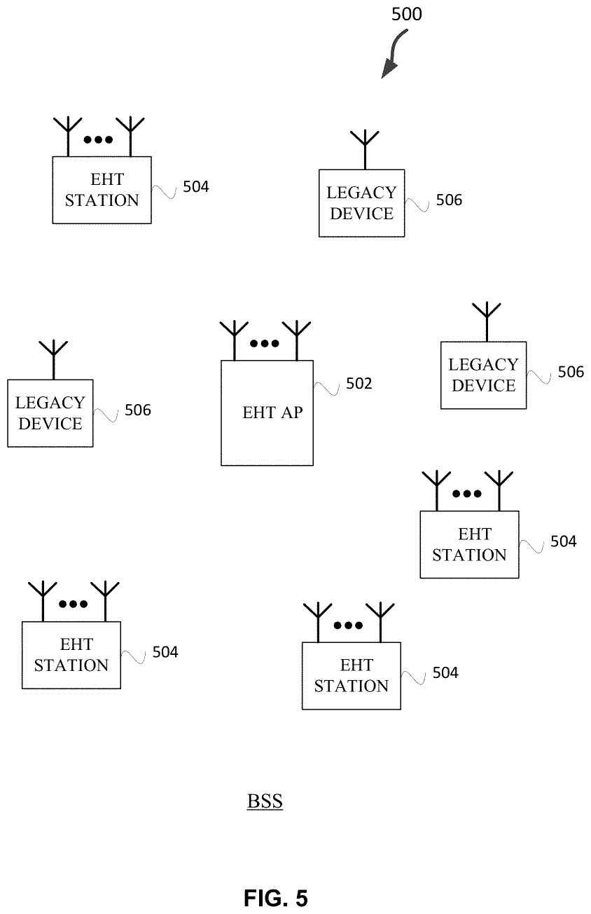

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+STAs.

In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502. IEEE P802.11be/D2.0, May 2022 is incorporated herein by reference.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be different types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a master station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy stations 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement.

In some embodiments station 504 may be a “group owner” (GO) for peer-to-peer modes of operation. A wireless device may be a Station 502 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to access point 502 and/or station 504 as well as legacy devices 506.

In some embodiments, a physical layer protocol data unit may be a physical layer conformance procedure (PLCP) protocol data unit (PPDU). In some embodiments, the AP and STAs may communicate in accordance with one of the IEEE 802.11 standards. IEEE Std 802.11-2020 is incorporated herein by reference. IEEE P802.11-REVmd/D2.4, August 2019, and IEEE draft specification IEEE P802.11ax/D5.0, October 2019 are incorporated herein by reference in their entireties. In some embodiments, the AP and STAs may be directional multi-gigabit (DMG) STAs or enhanced DMG (EDMG) STAs configured to communicate in accordance with IEEE 802.11ad standard or IEEE draft specification IEEE P802.1lay, February 2019, which is incorporated herein by reference.

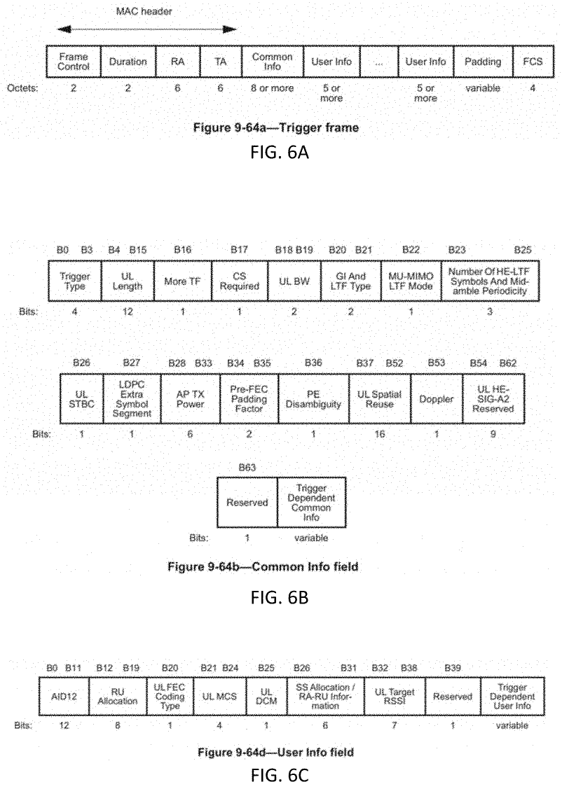

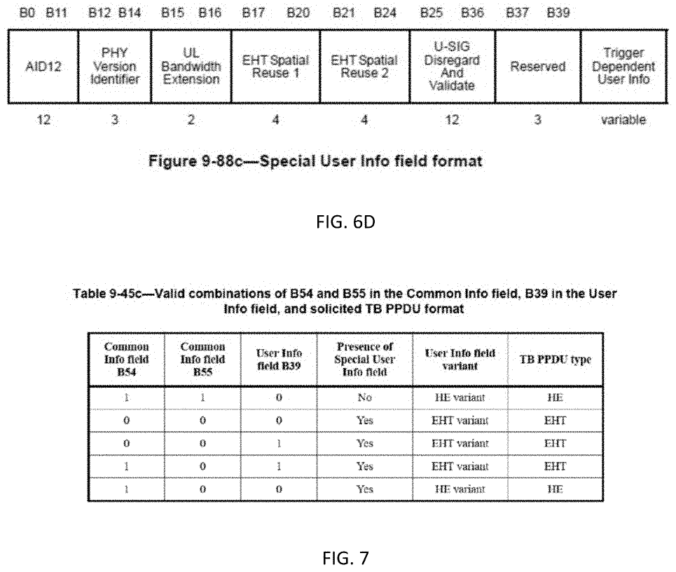

FIG. 6A illustrates a Trigger Frame format, in accordance with some embodiments.

FIG. 6B illustrates a Common Info field format, in accordance with some embodiments.

FIG. 6C illustrates a User Infor field format, in accordance with some embodiments.

FIG. 6D illustrates a Special User Info field format, in accordance with some embodiments.

Some embodiments are directed to a configuration of frequency domain aggregated PPDU. Some embodiments disclosed herein are directed to signalling for a frequency domain aggregated PPDU. The draft of 802.11be D3 states that “An EHT AP does not transmit a Trigger frame that solicits both an HE TB PPDU and an EHT TB PPDU as defined in 35.5.2.2.4”. However, it did not exclude the possibility where EHT STA could transmit HE/EHT PPDU within A-PPDU as shown in the last two rows in table 9-45c (see FIG. 7). FIG. 7 is table 9-45c illustrating valid combination of B54 and B44 in the Common Info field, B39 in the User Info field, and solicited TB PPDU format. Note that B54, which is HE/EHT P160 subfield of the EHT variant Common Info field, is set to 1 to indicate a HE PPDU in P160, and set to 0 to indicate EHT PPDU in P160. Note that B55, which is Special User Info Field Flag in the EHT variant Common Info field, is set to 0 to indicate that a Special User Info field is included in the Trigger frame that contains the EHT variant Common Info field. Otherwise, it does not. Note that B39, which is reserved for a non-EHT HE STA in an HE variant User Info field. It is the PS160 subfield for an EHT variant User Info field, which is set to 0 to indicate the assigned RU/MRU is within P160, and set to 1 to indicate the assigned RU/MRU is within S160.

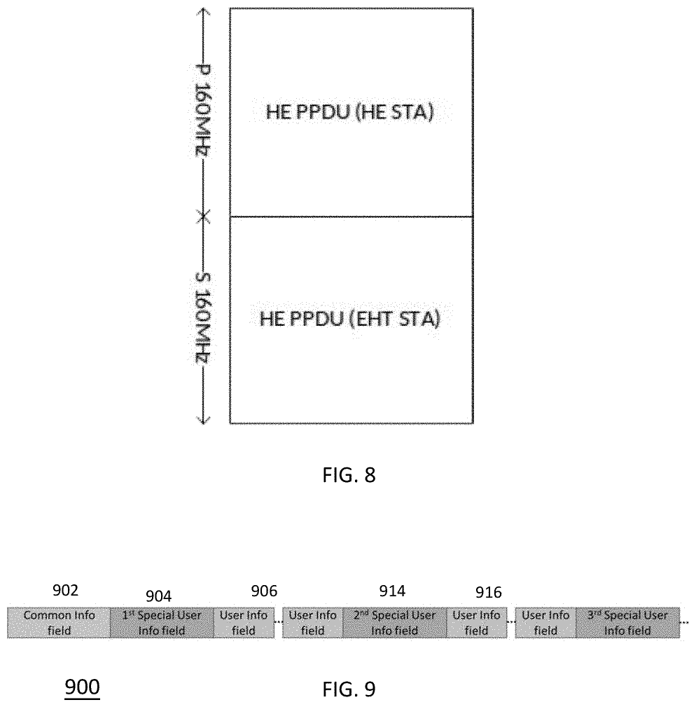

The definition that the User Info field is an HE variant addressed to a non-AP EHT STA if the B39 of the User Info field is set to 0 and the B54 of the Common Info field is set to 1 in the Trigger frame; otherwise, it is an EHT variant. This definition excludes the possibility that the AP can trigger An HE PPDU in P160 transmitted by HE STA, and another HE PPDU in S160 transmitted by EHT STA as shown in FIG. 8. FIG. 8 illustrates a TB-PPDU with PPDUs of the same PHY type.

There is only one PHY Version identifier in the Special User Info Field, which excludes the possibility that the AP can trigger more than one PPDU Types (EHT or EHT+), such as an EHT PPDU in P160 transmitted by EHT STA, and EHT+PPDU in S160 transmitted by EHT+STA, or EHT+PPDU in P160 transmitted by EHT+STA and EHT PPDU in S160 transmitted by EHT STA.

Some embodiments disclosed herein provide a signaling method to support an A-PPDU with a mixture of HE/EHT/EHT+PPDUs. Several Frequency Aggregated (FA)-PPDU configurations are proposed herein for use in 802.11uhr and a general FA-PPDU configuration is proposed for use in 802.11uhr and 802.11uhr+. For a trigger based FA-PPDU, embodiments disclosed herein provide the corresponding indications in the trigger frame for the FA-PPDU configurations.

The configuration of a FA-PPDU may be determined by several factors including the composite PPDU in the FA-PPDU, the bandwidth of the composite PPDU, the PPDU type of the composite PPDU, etc. There are several key parameters to configuring a FA-PPDU correctly in a TB FA-PPDU. These may include:
B54 of the Common Info field, which is set to 1 to indicate a HE PPDU in P160, and set to 0 to indicate non-HE PPDU in P160;
B55 of the Common Info field, which is set to 0 to indicate that a Special User Info field is included in the Trigger frame that contains the EHT variant Common Info field. Otherwise, it does not;
B39 of the User Info field, which is set to 0 to indicate the assigned RU/MRU is within P160, and set to 1 to indicate the assigned RU/MRU is within S160;
BW subfield in the Common Info field;
UL BW extension subfield in the special user info field;

Some embodiments disclosed herein propose to redefine B55 of the common info field as: set to 0 to indicate that a Special User Info field is included in the Trigger frame that contains the EHT, UHR or UHR+ variant Common Info field depending on the PHY version identifier in the following Special User Info field. Otherwise, it does not.

Some embodiments disclosed herein propose to redefine B56 of the common info field as: set to 0 to indicate that a second Special User Info field is included in the Trigger frame that contains the EHT, UHR or UHR+ variant Common Info field if B55=0. Otherwise, it does not.

FIG. 9 illustrates some fields of a Trigger Frame for soliciting a FA-PPDU having multiple different PHY version PPDU types, in accordance with some embodiments. Configurations of a 320 MHz FA-PPDU and the signaling for EHT, UHR or UHR+TB PPDU are described below.

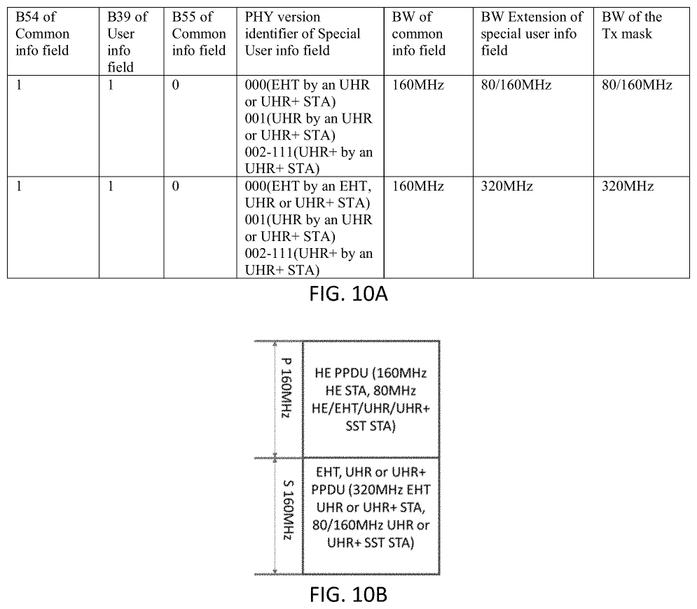

FIG. 10A illustrates signalling for a first example configuration, configuration 1, in accordance with some embodiments. FIG. 10B illustrates a FA-PPDU of configuration 1, in accordance with some embodiments. For this configuration:
P160: An HE PPDU in P160 transmitted by 160 MHz capable HE STAs, or by 80 MHz capable HE STAs over the P80 and 80 MHz capable HE/EHT/UHR/UHR+SST STAs over S80
S160: An EHT in S160 transmitted by 320 MHz capable EHT STA, or EHT, UHR or UHR+PPDU in S160 transmitted by 80, 160 or 320 MHz capable UHR or UHR+STA.

The signaling for an EHT STA transmit EHT TB PPDU; or UHR STA transmit EHT or UHR TB PPDU, or UHR+STA transmit EHT, UHR or UHR+TB PPDU in S160 to support FA-PPDU Config 1 is shown in in table 1 (see FIG. 10A).

Note: For the 80/160 MHz capable UHR or UHR+STA that can only support up to 80/160 MHz transmission and reception, if it is triggered to transmit or receive 80/160 MHz TB or MU PPDU over the S160 MHz within 320 MHz A-PPDU or an PPDU over one RU or MRU within the S160 MHz of the 320 MHz A-PPDU, it needs to switch from the primary 80/160 MHz to the non-primary 80/160 MHz within the S160 upon the reception of the basic trigger frame or MU-RTS trigger frame. It may use another more efficient channel switching scheme instead of SST. PHY/MAC padding in the trigger frame or control frame exchange between the AP and STA for channel switching request may be needed to give the STA enough time to complete the channel switching before the TB or MU PPDU transmission. An 80/160 MHz capable EHT STA may not be able to transmit or receive 80/160 MHz TB or MU PPDU over the S160 MHz within 320 MHz A-PPDU.

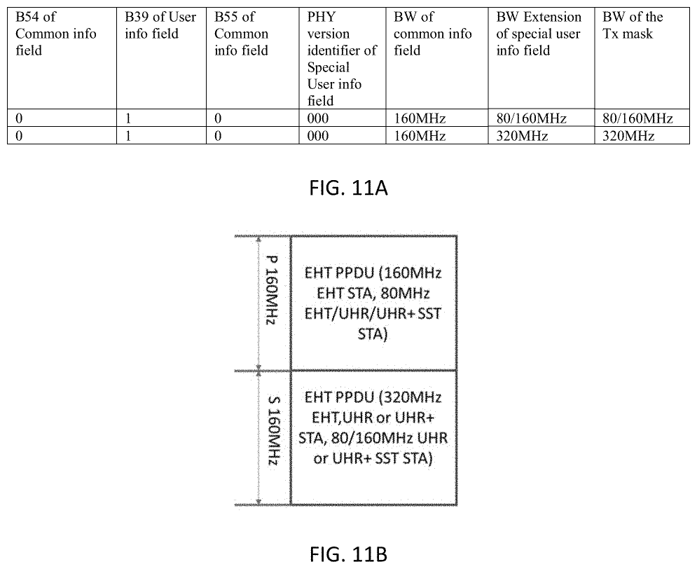

FIG. 11A illustrates signalling for a second example configuration, configuration 2, in accordance with some embodiments. FIG. 11B illustrates a FA-PPDU of configuration 2, in accordance with some embodiments. For this configuration:
P160: An EHT PPDU in P160 transmitted by 160 MHz capable EHT STAs, or by 80 MHz capable EHT STAs over the P80 and 80 MHz capable EHT/UHR/UHR+SST STAs over S80.
S160: An EHT PPDU in S160 transmitted by 80/160 MHz capable UHR or UHR+STA.

The signaling for the EHT, UHR or UHR+STA to transmit an EHT TB PPDU in S160 of the FA-PPDU of Config 2 is shown in in table 2 (see FIG. 11A). The signaling for the EHT STA to transmit an EHT TB PPDU in P160 of the FA-PPDU should set the B39 of User Info field to 0 for indicating the transmission in P160.

Note: For the 80/160 MHz capable UHR or UHR+STA, if it is triggered to transmit or receive 80/160 MHz TB or MU PPDU over the S160 MHz within 320 MHz A-PPDU or an PPDU over one RU or MRU within the S160 MHz of the 320 MHz A-PPDU, it needs to switch from the primary 160 MHz to the secondary 160 MHz upon the reception of the basic trigger frame or MU-RTS trigger frame. It may use another more efficient channel switching scheme instead of SST. PHY/MAC padding in the trigger frame or control frame exchange between the AP and STA for channel switching request may be needed to give the STA enough time to complete the channel switching before the TB or MU PPDU transmission. An 160 MHz capable EHT STA may not be able to transmit or receive 160 MHz TB or MU PPDU over the S160 MHz within 320 MHz A-PPDU.

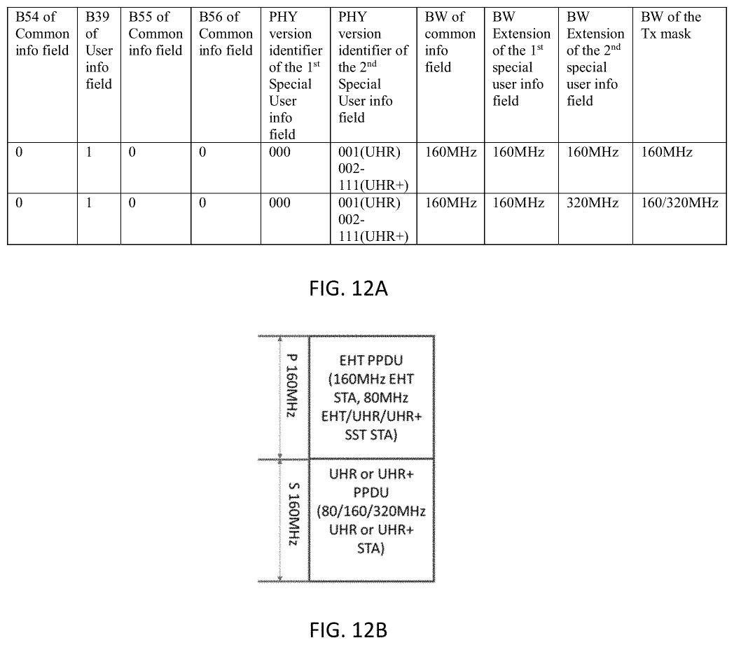

FIG. 12A illustrates signalling for a third example configuration, configuration 3, in accordance with some embodiments. FIG. 12B illustrates a FA-PPDU of configuration 3, in accordance with some embodiments. For this configuration:
P160: An EHT PPDU in P160 transmitted by 160 MHz capable EHT STAs, or by 80 MHz capable EHT STAs over the P80 and 80 MHz capable EHT/UHR/UHR+SST STAs over S80.
S160: An UHR or UHR+PPDU in S160 transmitted by 80/160/320 MHz capable UHR or UHR+STA.

The signaling for the UHR or UHR+STA to transmit an EHT TB PPDU in the FA-PPDU of Config 3 is shown in in table 3 (see FIG. 12A). Instead of a single Special User Info field in EHT, multiple Special User Info fields may be used in the trigger frame. For example, the first Special User Info field is readable by the ETH STA and the second and latter Special User Info field(s) may be only readable by UHR or UHR+STA. Although one special AID may be enough for identifying the special user info fields, one or multiple special AID(s) like 2007 or others may be defined in the spec for UHR and UHR+STA(s), which AP can't assign to STAs and by which the UHR and UHR+ can identify their own Special User Info field(s). One or more reserved bits between B37-B39 in the Special User Info field may be used to indicate that this Special User Info field is for which 80 MHz, 160 MHz or 320 MHz channel.

The bandwidth of the transmission mask of the UHR or UHR+STA that transmits in S160 can be 80, 160 or 320 MHz. For example, if the UHR or UHR+STA is 80/160 MHz capable, then the transmission mask is 80/160 MHz. For another example, if the UHR or UHR+STA is 320 MHz capable, then the transmission mask may be either 320 MHz or 160 MHz with the tradeoff between interference level and implementation complexity. It is likely that the spec will define the transmission mask to be the smallest subchannel bandwidth covering the allocated transmission, which is 160 MHz in this example.

Note: For the 80/160 MHz capable UHR or UHR+STA, if it is triggered to transmit or receive 80/160 MHz TB or MU PPDU over the S160 MHz within 320 MHz A-PPDU or an PPDU over one RU or M-RU within the S160 MHz of the 320 MHz A-PPDU, it needs to switch from the primary 80/160 MHz to the non-primary channel upon the reception of the basic trigger frame or MU-RTS trigger frame. It may use another more efficient channel switching scheme instead of SST. PHY/MAC padding in the trigger frame or control frame exchange between the AP and STA for channel switching request may be needed to give the STA enough time to complete the channel switching before the TB or MU PPDU transmission.

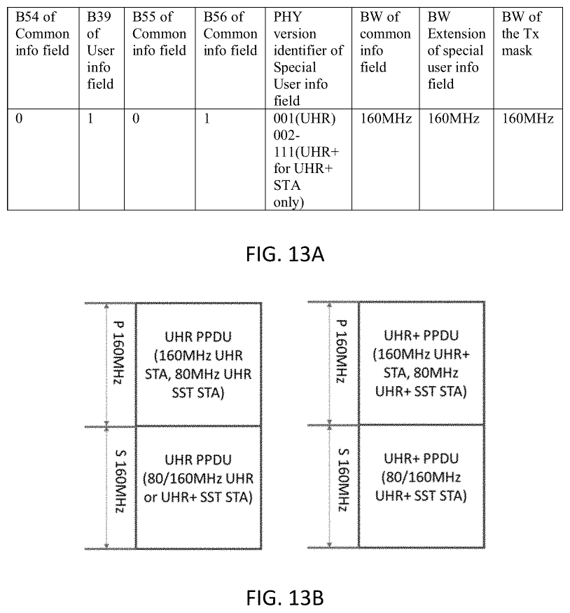

FIG. 13A illustrates signalling for a fourth example configuration, configuration 4, in accordance with some embodiments. FIG. 13B illustrates a FA-PPDU of configuration 4, in accordance with some embodiments. For this configuration, an UHR PPDU in P160 transmitted by 80/160 MHz capable UHR STAs, and an UHR PPDU in S160 transmitted by 80/160 MHz capable UHR or UHR+STA. Or an UHR+PPDU in P160 by a 80/160 MHz capable UHR+STA, and an UHR+PPDU in S160 transmitted by a 80/160 MHz capable UHR+STA.

The signaling for an UHR or UHR+STA transmit EHT TB PPDU to support FA-PPDU of Config 4 is shown in in table 4 (see FIG. 13A). Although one Special User Info field may be enough as shown in table 4 (see FIG. 13A), multiple Special User Info field may provide additional flexibility. Namely, for each PHY version like UHR and UHR+, a different Special User Info field be used. Different Special User Info fields may be identified by different special AIDs, respectively. The contents of each special user info fields can be different to address the needs of different PHY versions.

Note: For the 80/160 MHz capable UHR or UHR+STA, if it is triggered to transmit or receive 80/160 MHz TB or MU PPDU over the S160 MHz within 320 MHz A-PPDU or an PPDU over one RU or MRU within the S160 MHz of the 320 MHz A-PPDU, it needs to switch from the primary 80/160 MHz channel to the non-primary 80/160 MHz channel upon the reception of the basic trigger frame or MU-RTS trigger frame. It may use another more efficient channel switching scheme instead of SST. PHY/MAC padding in the trigger frame or control frame exchange between the AP and STA for channel switching request may be needed to give the STA enough time to complete the channel switching before the TB or MU PPDU transmission.

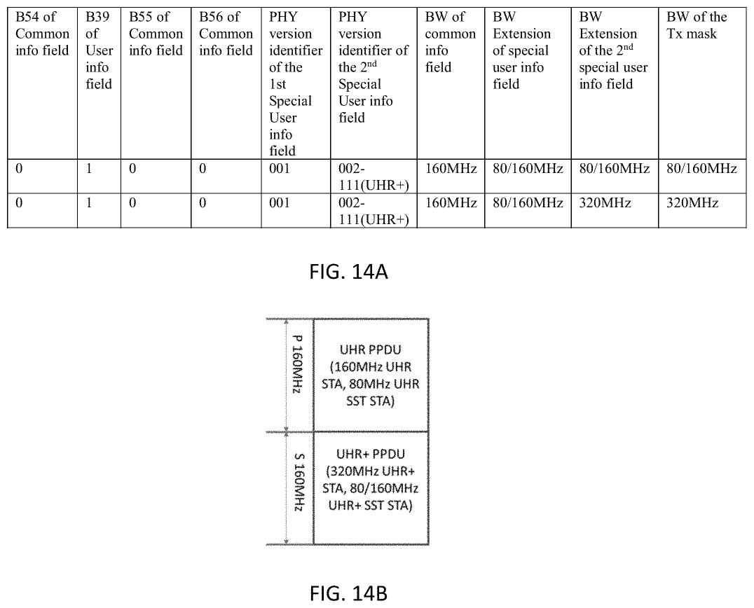

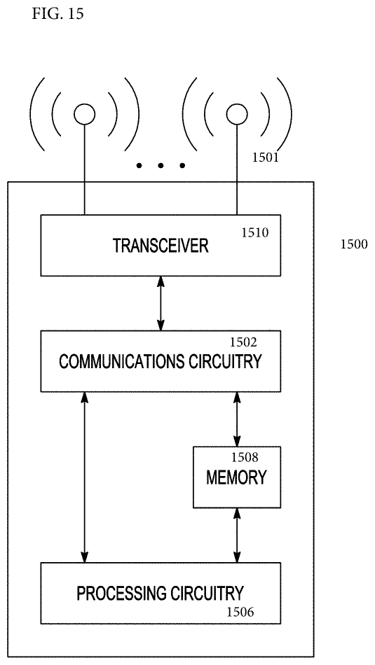

FIG. 14A illustrates signalling for a fifth example configuration, configuration 5, in accordance with some embodiments. FIG. 14B illustrates a FA-PPDU of configuration 5, in accordance with some embodiments. For this configuration:
An UHR PPDU in P160 transmitted by UHR or UHR+STA, and an UHR+PPDU in S160 transmitted by 80/160/320 MHz capable UHR+STA.

The signaling for an UHR+STA transmit UHR+TB PPDU to support FA-PPDU of Config 5 is shown in in table 5 (see FIG. 14A). The bandwidth of the transmission mask of the UHR+STA that transmits in S160 can be 80,160 or 320 MHz. For example, if the UHR+STA is 80/160 MHz capable, then the transmission mask is 80/160 MHz. For another example, if the UHR+STA is 320 MHz capable, then the transmission mask may be either 320 MHz or 160 MHz with the tradeoff between interference level and implementation complexity. It is likely that the spec will define the transmission mask to be the smallest subchannel bandwidth covering the allocated transmission, which is 160 MHz in this example.

In the examples above, only one STA is allocated in each 160 MHz subchannel. In general, one or multiple STAs can be triggered in each RU allocated in the trigger frame.

General Configuration for UHR and UHR+

When B54=0, there is no HE PPDU within the A-PPDU, B54+n is used to indicate whether there is nth special user info field, if B(54+n)=1, B(54+n+1) is reserved value. There are n PHY version PPDUs within the A-PPDU, the latest version common info field will be used for the common info field, the special user info fields will be ordered along with the B55 to B(54+n) with AID=2007. The user info fields for each 160 MHz follow the related Special User info field before the next Special User info field as shown following. (see FIG. 9).

Note that the general configuration can be extended to support up to N different PHY version PPDU types within N×160 MHz A-PPDU. Maximum number of PHY version PPDU types may be defined in the spec to minimize the complexity. Another bit or several bits within user info field is needed to indicate the assigned RU/MRU is over which 160 MHz within the N×160 MHz A-PPDU.

For example if the supported bandwidth is up to 3×160 MHz, propose to redefine B57 of the common info field as: set to 0 to indicate that a third Special User Info field is included in the Trigger frame that contains the EHT, UHR or UHR+ variant Common Info field. Otherwise, it does not.

For example, if the supported bandwidth is up to 4×160 MHz, Propose to redefine B58 of the common info field as: set to 0 to indicate that a fourth Special User Info field is included in the Trigger frame that contains the EHT, UHR or UHR+ variant Common Info field. Otherwise, it does not.

For a 160 MHz capable UHR or UHR+STA, if it is triggered to transmit or receive 160 MHz TB or MU PPDU over the S160 MHz within 320 MHz A-PPDU or an PPDU over one RU or M-RU within the S160 MHz of the 320 MHz A-PPDU, it needs to switch from the primary 160 MHz to the secondary 160 MHz. PHY/MAC padding in the trigger frame or control frame exchange between the AP and STA for channel switching request may be needed to give the STA enough time to complete the channel switching before the TB or MU PPDU transmission. These configurations may be suitable for cases where the operation channel bandwidth of the STA is narrower than the AP's operation channel bandwidth, although the scope of the embodiments is not limited in this respect.

Some embodiments are directed to an access point station (AP) configured to solicit a trigger-based (TB) Frequency Aggregated Physical layer Protocol Data Unit (PPDU) (FA-PPDU) that includes more than one PPDU of at least two different physical layer (PHY) types from the two or more STAs or groups of STAs. In these embodiments, the AP may generate a trigger frame (TF) 900 (see FIG. 9) for transmission to two or more non-AP stations (STAs). The trigger frame 900 may allocate resource units (RUs) for a trigger-based (TB) transmission. The trigger frame 900 be encoded to include a Common Info field 902 followed by one or more Special User Info fields 904 and 914.

In these embodiments, the Common Info field 902 and the one or more Special User Info fields 904 and 914 may be encoded to solicit (i.e., trigger) a trigger-based (TB) Frequency Aggregated Physical layer Protocol Data Unit (PPDU) (FA-PPDU) that includes more than one PPDU of at least two different physical layer (PHY) types from the two or more STAs or groups of STAs. In these embodiments, the different PHY types may include high-efficiency (HE), Extremely High Throughput (EHT), Ultra-High Rate (UHR), and UHR+. The AP may decode the FA-PPDU received from the two or more STAs.

Accordingly, the AP can trigger a FA-PPDU that includes TB PPDUs of different PHY types. For example, the FA-PPDU may comprise an HE PPDU transmitted in a first bandwidth by an HE STA and an EHT PPDU in a second bandwidth transmitted by an EHT STA. For example, the FA-PPDU may comprise an EHT PPDU transmitted in the first bandwidth by an EHT STA and an UHR PPDU in the second bandwidth transmitted by a UHR STA.

In some embodiments, when the trigger frame 900 contains one of an EHT, UHR and UHR+ variant Common Info field, the Common Info field 902 is encoded to indicate (i.e., via B55) whether or not a first Special User Info field 904 is included in the trigger frame 900 that contains the EHT, UHR or UHR+ variant Common Info field, the first Special User Info field 904 following the Common Info field 902 in the trigger frame 900. In these embodiments, when the first Special User Info field 904 is included in the trigger frame 900, the first Special User Info field 904 may include a PHY version identifier to indicate whether the trigger frame 900 contains the EHT variant Common Info field, the UHR variant Common Info field or the UHR+ variant Common Info field.

In these embodiments, the Common Info field 902 may be a variant Common Info field comprising either the EHT variant Common Info field, the UHR variant Common Info field or the UHR+ variant Common Info field. In these embodiments, when the trigger frame contains the EHT, the UHR or the UHR+ variant Common Info field, bit 55 (B55) of the EHT, the UHR or the UHR+ variant Common Info field may be set to a first predetermined value (e.g., zero) to indicate that a first Special User Info field is included in the trigger frame.

In some embodiments, when the trigger frame 900 contains one of the EHT, the UHR and the UHR+ variant Common Info field and when the Common Info field 902 is encoded to indicate (i.e., via B55) that the first Special User Info field 904 is included in the trigger frame (e.g., B55 may be set to zero), the AP may indicate (i.e., via B56) whether or not a second Special User Info field 914 is included in the trigger frame that contains the EHT, UHR or UHR+ variant Common Info field.

In some embodiments, when the trigger frame 900 contains one of the EHT, the UHR and the UHR+ variant Common Info field and when the trigger frame 900 is encoded to include the first Special User Info field 904, the trigger frame 900 may further be encoded to include one or more first User Info fields 906 following the first Special User Info field 904. In these embodiments, each of the first User Info fields 906 may include information for a trigger-based PPDU transmission by a STA of a first group of one or more STAs. In these embodiments, the PHY version identifier of the first Special User Info field 904 may be encoded to indicate a PHY type for the trigger-based PPDU transmission by each STA of the first group.

In some embodiments, when the trigger frame 900 contains one of the EHT, the UHR and the UHR+ variant Common Info field and when the trigger frame 900 is encoded to include the second Special User Info field 914, the trigger frame 900 may further be encoded to include one or more second User Info fields 916 following the second Special User Info field 914. In these embodiments, each of the second User Info fields 916 may include information for a trigger-based PPDU transmission by a STA of a second group of one or more STAs. In these embodiments, a PHY version identifier of the second Special User Info field 914 may be encoded to indicate a PHY type for the trigger-based PPDU transmission by each STA of the second group.

In these embodiments, the trigger frame 900 may include a first User Info field 906 for each STA of the first group following the first Special User Info field 904 and may include a second User Info field 916 for each STA of the second group following the second Special User Info field 914.

In some embodiments, the trigger-based PPDU transmission by each of the one or more STAs of the first group may comprise a first PHY type, and the trigger-based PPDU transmission by each of the one or more STAs of the second group may comprise a second PHY type that is configurable to be different than the first PHY type.

In some embodiments, the trigger-based PPDU transmission by each of the one or more STAs of the first group and the trigger-based PPDU transmission by each of the one or more STAs of the second group comprise the FA-PPDU that includes more than one PPDU of different PHY types (e.g., HE, EHT, UHR or UHR+) from the two or more STAs or groups of STAs.

In some embodiments, for a 320 MHz FA-PPDU, each of one or more first User Info Fields 906 and each of the one or more second User Info Fields 916 may be encoded to indicate (e.g., B39) whether a RU assigned to a STA is within a primary 160 MHz subchannel (P160) or a second 160 MHz subchannel (S160). In these embodiments, the trigger frame 900 may further be encoded to include a bandwidth (BW) extension for each of the Special User Info fields 904 and 914 for use by the STAs in setting a transmit (Tx) mask for transmission of their trigger-based PPDUs within a bandwidth allocated to the STA, the BW extension based on a supported bandwidth of the STAs. Accordingly, an AP can trigger a FA-PPDU that includes for example, an HE PPDU in P160 transmitted by HE STA, and an EHT PPDU in S160 transmitted by EHT STA, or, for example, an EHT PPDU in P160 transmitted by EHT STA, and an UHR PPDU in S160 transmitted by UHR STA.

In some embodiments, the PHY version identifier of the first Special User Info field 904 may be set to a first value (i.e., 000) (see for example, FIG. 10A) to indicate that the trigger-based PPDU transmission by each of the one or more STAs of the first group comprise an EHT trigger-based PPDU transmission by an EHT, UHR or UHR+STA. In these embodiments, the PHY version identifier of the first Special User Info field 904 may be set to a second value (i.e., 001) to indicate that the trigger-based PPDU transmission by each of the one or more STAs of the first group comprise an UHR trigger-based PPDU transmission by an UHR or UHR+STA. In these embodiments, the PHY version identifier of the first Special User Info field 904 may be set to a third value (i.e., 002-111) to indicate that the trigger-based PPDU transmission by each of the one or more STAs of the first group comprise an UHR+ trigger-based PPDU transmission by a UHR+STA.

In some embodiments, the PHY version identifier of the second Special User Info field 914 may be set to the first value (i.e., 000) to indicate that the trigger-based PPDU transmission by each of the one or more STAs of the second group comprise an EHT trigger-based PPDU transmission by an EHT, UHR or UHR+STA. In these embodiments, the PHY version identifier of the second Special User Info field 914 may be set to the second value (i.e., 001) to indicate that the trigger-based PPDU transmission by each of the one or more STAs of the second group comprise an UHR trigger-based PPDU transmission by an UHR or UHR+STA. In these embodiments, the PHY version identifier of the second Special User Info field 914 may be set to the third value (i.e., 002-111) to indicate that the trigger-based PPDU transmission by each of the one or more STAs of the second group comprise an UHR+ trigger-based PPDU transmission by a UHR+STA.

In these embodiments, the Special User Info fields 904, 914 do not carry the user specific information but carry extended common information not provided in the Common Info field variant. The first Special User Info fields 904, if present, are located immediately after the Common Info field 902 of the Trigger frame 900 and carry information for the U-SIG field of the solicited TB PPDU.

Some embodiments are directed to a non-transitory computer-readable storage medium that stores instructions for execution by processing circuitry of an access point (AP). In these embodiments, the processing circuitry may be configured to generate a trigger frame (TF) 900 for transmission to two or more non-AP stations (STAs) to allocate resource units (RUs) for a trigger-based (TB) transmission. The processing circuitry may also encode the trigger frame 900 to include a Common Info field 902 followed by one or more Special User Info fields 904 and 914 as discussed above.

Some embodiments are directed to a non-access point station (STA). In these embodiments, the STA may decode a trigger frame (TF) 900 received from an access point station (AP). The trigger frame 900 may allocate resource units (RUs) for a trigger-based (TB) transmission by two or more non-AP stations (STAs). The trigger frame 900 may including a Common Info field 902 followed by one or more Special User Info fields 904 and 914. In these embodiments, the Common Info field 902 and the one or more Special User Info fields 904 and 914 are encoded to solicit (i.e., trigger) a trigger-based (TB) Frequency Aggregated Physical layer Protocol Data Unit (PPDU) (FA-PPDU) that includes more than one PPDU of at least two different physical layer (PHY) types from the two or more STAs or groups of STAs.

FIG. 15 illustrates a functional block diagram of a wireless communication device, in accordance with some embodiments. In some embodiments, FIG. 15 illustrates a functional block diagram of a communication device (STA) that may be suitable for use as an AP STA, a non-AP STA or other user device in accordance with some embodiments. The wireless communication device 1500 may also be suitable for use as a handheld device, a mobile device, a cellular telephone, a smartphone, a tablet, a netbook, a wireless terminal, a laptop computer, a wearable computer device, a femtocell, a high data rate (HDR) subscriber device, an access point, an access terminal, or other personal communication system (PCS) device.

The wireless communication device 1500 may include communications circuitry 1502 and a transceiver 1510 for transmitting and receiving signals to and from other communication devices using one or more antennas 1501. The communications circuitry 1502 may include circuitry that can operate the physical layer (PHY) communications and/or medium access control (MAC) communications for controlling access to the wireless medium, and/or any other communications layers for transmitting and receiving signals. The wireless communication device 1500 may also include processing circuitry 1506 and memory 1508 arranged to perform the operations described herein. In some embodiments, the communications circuitry 1502 and the processing circuitry 1506 may be configured to perform operations detailed in the above figures, diagrams, and flows.

In accordance with some embodiments, the communications circuitry 1502 may be arranged to contend for a wireless medium and configure frames or packets for communicating over the wireless medium. The communications circuitry 1502 may be arranged to transmit and receive signals. The communications circuitry 1502 may also include circuitry for modulation/demodulation, upconversion/downconversion, filtering, amplification, etc. In some embodiments, the processing circuitry 1506 of the wireless communication device 1500 may include one or more processors. In other embodiments, two or more antennas 1501 may be coupled to the communications circuitry 1502 arranged for sending and receiving signals. The memory 1508 may store information for configuring the processing circuitry 1506 to perform operations for configuring and transmitting message frames and performing the various operations described herein. The memory 1508 may include any type of memory, including non-transitory memory, for storing information in a form readable by a machine (e.g., a computer). For example, the memory 1508 may include a computer-readable storage device, read-only memory (ROM), random-access memory (RAM), magnetic disk storage media, optical storage media, flash-memory devices and other storage devices and media.

In some embodiments, the wireless communication device 1500 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 1500 may include one or more antennas 1501. The antennas 1501 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 1500 may include one or more of a keyboard, a display, a non-volatile memory port, multiple antennas, a graphics processor, an application processor, speakers, and other mobile device elements. The display may be an LCD screen including a touch screen.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an access point (AP), the AP comprising: processing circuitry; and memory, wherein the processing circuitry is configured to:
generate a trigger frame (TF) for transmission to two or more non-AP stations (STAs), the trigger frame to allocate resource units (RUs) for a trigger-based (TB) transmission, the processing circuitry to encode the trigger frame to include a Common Info field followed by one or more Special User Info fields,
wherein the Common Info field and the one or more Special User Info fields are encoded to solicit a trigger-based (TB) Frequency Aggregated Physical layer Protocol Data Unit (PPDU) (FA-PPDU) that includes more than one PPDU of at least two different physical layer (PHY) types from the two or more STAs, the different PHY types including high-efficiency (HE), Extremely High Throughput (EHT), Ultra-High Rate (UHR), and UHR+; and
decode the FA-PPDU received from the two or more STAs.

2. The apparatus of claim 1, wherein when the trigger frame contains one of an EHT, UHR and UHR+ variant Common Info field:
the Common Info field is encoded to indicate whether a Special User Info field is included in the trigger frame, the Special User Info field following the Common Info field in the trigger frame, and
wherein when the Special User Info field is included in the trigger frame, the Special User Info field includes a PHY version identifier to indicate whether the trigger frame contains the EHT variant Common Info field, the UHR variant Common Info field or the UHR+ variant Common Info field.

3. The apparatus of claim 2, wherein when the trigger frame contains one of the EHT, the UHR and the UHR+ variant Common Info field and when the Common Info field is encoded to indicate that the Special User Info field is included in the trigger frame, the processing circuitry is configured to:
indicate whether a second Special User Info field is included in the trigger frame.

4. The apparatus of claim 3, wherein when the trigger frame contains one of the EHT, the UHR and the UHR+ variant Common Info field and wherein when the trigger frame is encoded to include the Special User Info field, the trigger frame is further encoded to include one or more User Info fields following the Special User Info field, each of the User Info fields containing information for a trigger-based PPDU transmission by a STA of a first group of one or more STAs, and
wherein the PHY version identifier of the Special User Info field is encoded to indicate a PHY type for the trigger-based PPDU transmission by each STA of the first group.

5. The apparatus of claim 4, wherein when the trigger frame contains one of the EHT, the UHR and the UHR+ variant Common Info field and wherein when the trigger frame is encoded to include the second Special User Info field, the trigger frame is further encoded to include one or more second User Info fields following the second Special User Info field, each of the second User Info fields containing information for a trigger-based PPDU transmission by a STA of a second group of one or more STAs, and
wherein a PHY version identifier of the second Special User Info field is encoded to indicate a PHY type for the trigger-based PPDU transmission by each STA of the second group.

6. The apparatus of claim 5, wherein the trigger-based PPDU transmission by each of the one or more STAs of the first group comprise a first PHY type, and
wherein the trigger-based PPDU transmission by each of the one or more STAs of the second group comprise a second PHY type.

7. The apparatus of claim 6, wherein the trigger-based PPDU transmission by each of the one or more STAs of the first group and the trigger-based PPDU transmission by each of the one or more STAs of the second group comprise the FA-PPDU.

8. The apparatus of claim 7, wherein for a 320 MHz FA-PPDU, each of one or more first User Info Fields and each of the one or more second User Info Fields are encoded to indicate whether a RU assigned to a STA is within a primary 160 MHz subchannel (P160) or a second 160 MHz subchannel (S160), and
wherein the trigger frame is further encoded to include a bandwidth (BW) extension for each of the Special User Info fields for use by the STAs in setting a transmit (Tx) mask for transmission of their trigger-based PPDUs within a bandwidth allocated to the STA, the BW extension based on a supported bandwidth of the STAs.

9. The apparatus of claim 8, wherein the PHY version identifier of the first Special User Info field is set to a first value to indicate that the trigger-based PPDU transmission by each of the one or more STAs of the first group comprise an EHT trigger-based PPDU transmission by an EHT, UHR or UHR+STA,
wherein the PHY version identifier of the first Special User Info field is set to a second value to indicate that the trigger-based PPDU transmission by each of the one or more STAs of the first group comprise an UHR trigger-based PPDU transmission by an UHR or UHR+STA, and
wherein the PHY version identifier of the first Special User Info field is set to a third value to indicate that the trigger-based PPDU transmission by each of the one or more STAs of the first group comprise an UHR+ trigger-based PPDU transmission by a UHR+STA.

10. The apparatus of claim 9, wherein the PHY version identifier of the second Special User Info field is set to the first value to indicate that the trigger-based PPDU transmission by each of the one or more STAs of the second group comprise an EHT trigger-based PPDU transmission by an EHT, UHR or UHR+STA,
wherein the PHY version identifier of the second Special User Info field is set to the second value to indicate that the trigger-based PPDU transmission by each of the one or more STAs of the second group comprise an UHR trigger-based PPDU transmission by an UHR or UHR+STA, and
wherein the PHY version identifier of the second Special User Info field is set to the third value to indicate that the trigger-based PPDU transmission by each of the one or more STAs of the second group comprise an UHR+ trigger-based PPDU transmission by a UHR+STA.

11. A non-transitory computer-readable storage medium that stores instructions for execution by processing circuitry of an access point (AP), wherein the processing circuitry is configured to:
generate a trigger frame (TF) for transmission to two or more non-AP stations (STAs), the trigger frame to allocate resource units (RUs) for a trigger-based (TB) transmission, the processing circuitry to encode the trigger frame to include a Common Info field followed by one or more Special User Info fields,
wherein the Common Info field and the one or more Special User Info fields are encoded to solicit a trigger-based (TB) Frequency Aggregated Physical layer Protocol Data Unit (PPDU) (FA-PPDU) that includes more than one PPDU of at least two different physical layer (PHY) types from the two or more STAs, the different PHY types including high-efficiency (HE), Extremely High Throughput (EHT), Ultra-High Rate (UHR), and UHR+; and
decode the FA-PPDU received from the two or more STAs.

12. The non-transitory computer-readable storage medium of claim 11, wherein when the trigger frame contains one of an EHT, UHR and UHR+ variant Common Info field:
the Common Info field is encoded to indicate whether a Special User Info field is included in the trigger frame, the Special User Info field following the Common Info field in the trigger frame, and
wherein when the Special User Info field is included in the trigger frame, the Special User Info field includes a PHY version identifier to indicate whether the trigger frame contains the EHT variant Common Info field, the UHR variant Common Info field or the UHR+ variant Common Info field.

13. The non-transitory computer-readable storage medium of claim 12, wherein when the trigger frame contains one of the EHT, the UHR and the UHR+ variant Common Info field and when the Common Info field is encoded to indicate that the Special User Info field is included in the trigger frame, the processing circuitry is configured to:
indicate whether a second Special User Info field is included in the trigger frame.

14. The non-transitory computer-readable storage medium of claim 13, wherein when the trigger frame contains one of the EHT, the UHR and the UHR+ variant Common Info field and wherein when the trigger frame is encoded to include the Special User Info field, the trigger frame is further encoded to include one or more User Info fields following the Special User Info field, each of the User Info fields containing information for a trigger-based PPDU transmission by a STA of a first group of one or more STAs, and
wherein the PHY version identifier of the Special User Info field is encoded to indicate a PHY type for the trigger-based PPDU transmission by each STA of the first group.

15. The non-transitory computer-readable storage medium of claim 14, wherein when the trigger frame contains one of the EHT, the UHR and the UHR+ variant Common Info field and wherein when the trigger frame is encoded to include the second Special User Info field, the trigger frame is further encoded to include one or more second User Info fields following the second Special User Info field, each of the second User Info fields containing information for a trigger-based PPDU transmission by a STA of a second group of one or more STAs, and
wherein a PHY version identifier of the second Special User Info field is encoded to indicate a PHY type for the trigger-based PPDU transmission by each STA of the second group.

16. The non-transitory computer-readable storage medium of claim 15, wherein the trigger-based PPDU transmission by each of the one or more STAs of the first group comprise a first PHY type, and
wherein the trigger-based PPDU transmission by each of the one or more STAs of the second group comprise a second PHY type.

17. The non-transitory computer-readable storage medium of claim 16, wherein the trigger-based PPDU transmission by each of the one or more STAs of the first group and the trigger-based PPDU transmission by each of the one or more STAs of the second group comprise the FA-PPDU.

18. The non-transitory computer-readable storage medium of claim 17, wherein for a 320 MHz FA-PPDU, each of one or more first User Info Fields and each of the one or more second User Info Fields are encoded to indicate whether a RU assigned to a STA is within a primary 160 MHz subchannel (P160) or a second 160 MHz subchannel (S160), and
wherein the trigger frame is further encoded to include a bandwidth (BW) extension for each of the Special User Info fields for use by the STAs in setting a transmit (Tx) mask for transmission of their trigger-based PPDUs within a bandwidth allocated to the STA, the BW extension based on a supported bandwidth of the STAs.

19. An apparatus of a non-access point station (STA), the apparatus comprising: processing circuitry; and memory, wherein the processing circuitry is configured to:
decode a trigger frame (TF) received from an access point station (AP), the trigger frame to allocate resource units (RUs) for a trigger-based (TB) transmission by two or more non-AP stations (STAs), the trigger frame including a Common Info field followed by one or more Special User Info fields,
wherein the Common Info field and the one or more Special User Info fields are encoded to solicit a trigger-based (TB) Frequency Aggregated Physical layer Protocol Data Unit (PPDU) (FA-PPDU) that includes more than one PPDU of at least two different physical layer (PHY) types from the two or more STAs, the different PHY types including high-efficiency (HE), Extremely High Throughput (EHT), Ultra-High Rate (UHR), and UHR+; and
encode a trigger-based PPDU for transmission to the AP, the trigger-based PPDU being part of the FA-PPDU received from the two or more STAs.

20. The apparatus of claim 19, wherein when the trigger frame contains one of an EHT, UHR and UHR+ variant Common Info field, the processing circuitry is configured to decode the Common Info field to determine whether a Special User Info field is included in the trigger frame, the Special User Info field following the Common Info field in the trigger frame, and
wherein when the Special User Info field is included in the trigger frame, processing circuitry is configured to decode the Special User Info field to determine a PHY version identifier to indicate whether the trigger frame contains the EHT variant Common Info field, the UHR variant Common Info field or the UHR+ variant Common Info field.
